(19) United States
(12) Patent Application Publication
(10) Pub. No.: US 2010/0317377 A1
(43) Pub. Date: Dec. 16, 2010

(54) Queue Management System Allows queue number to be remotely obtained by Patients or customers

(76) Inventors: Lin Zou, ShenZhen (CN); John Schum, Hiawatha, KS (US)

Correspondence Address: John Schum, 306 N. 5th Street, Hiawatha, KS, 66434, US

(21) Appl. No.: 12/483,466

(22) Filed: Jun. 12, 2009

(51) Int. Cl. H04W 4/12

(52) U.S. Cl. 455/466

(57) ABSTRACT

A device for queue management which can receive and transmit a Short Message Service (SMS) text. The patient or customer would be the sender requesting a queue number via SMS. Phone caller ID will also be utilized. Thereafter the queue management device or computer system will generate a queue number and send back to the patient or customer via SMS the requested queue number, the estimated time of service and/or approximate time that customer must be present at the waiting hall as well as current number of customer being served. Also a LED display and computing device will display current queue number being served as well. The walk-in customer can also press the touch screen button to get the printed queue ticket. The printed queue number will be consistent and concurrent with queue numbers issued and sent to remote customers.

### LIMITED COPYRIGHT WAIVER

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2009, A. Veradej dba Security Solutions Systems

### US PATENT REFERENCES

U.S. Pat. D581984 Publication Date: 12/02/2008 Bergstrom, D20/2
U.S. Pat. D581983 Publication Date: 12/02/2008 Bergström, D20/2
U.S. Pat. D519548 Publication Date: 04/25/2006 Bergström, D18/50
U.S. Pat. No. 7,278,579 Publication Date: Oct. 9, 2007 Loffredo, Cathy A. et al. 235/462.460
U.S. Pat. No. 7,215,759 Publication Date: 05/08/2007 Brown, Michael Wayne et al. 379/266.060
U.S. Pat. No. 7,369,865 Publication Date: 05/06/2008 Gabriel, Manny et al. 455/466

### FIELD

Embodiments of the inventive subject matter relate generally to a Queue management system for Hospital patients waiting to receive aid or health care treatment services. Also applicable to other non related customer service industries that necessitate a person having to wait for a service or accommodation to be performed or obtained. This unique, ingenious method and system in particular allows the queue requester to remotely and directly obtain a line position or turn number. This is accomplished by the person (requester) contacting the Queue management program using Short Message Service (SMS) and cellular telephone or land telephone or internet. Or physically going into the facility and press button on the touch screen to get a ticket, from the queue management machine device. Whereupon receiving a queue position number that is synchronized with the ongoing queue number total for that facility. The potential positive results of using the Queue Management system will be many. The patient or customer will save a vast amount of time that could be better used elsewhere thus increasing exponentially the productivity quotient of the individual in a society and thus the society at large. The person will also not have to drive around endlessly to try to find a parking space or feed meter. This would result in energy savings and less pollution in the air, two very favorable goals of any modern society.

Think of the Queue management system as a time management system, and resource multiplier. With an advanced appointment system like this the resources of personnel and building space limitations are increased by a sizable factor. Thus, this system is in effect a huge revenue generator. This is accomplished by increasing the effectiveness of these existing resources by superior utilization at a fraction of the cost of more personnel and new facilities. The reader can undoubtedly conclude numerous other benefits of employing this system. In general we also believe that there will be a positive reaction by the populous, in that one of the many exasperating problems of modern life will become less of a headache.

### BACKGROUND

Over the years numerous articles and commentaries have been presented concerning the growing problem and inefficiency of health care providing. This is especially applicable to societies with socialized medicine and large populations. Also this is relevant to any necessity to access government facilities or agencies such as DMV, social security or passport application office. The need for thousands of people to wait in line for six, eight or more hours to receive basic service is commonplace.

Health risk and potential contagion for all patients will be reduced by this invention by the simple result of less crowding thus less exposure to both airborne or direct contact to another person's germs.

Extended delay in any hospital waiting facility can result in contracting a virus or disease. Many people waiting for so many hours, some all day to see a doctor for treatment in the hospital is a dangerous situation. One can easily contract a more serious disease from others while one is in the waiting room and then spread this to family and other contacts thus intensifying the epidemic. Not to mention the effect of exposure to the terrible antibiotic resistant strains of staff that we have all read about that are present in most hospitals around the world.

Imagine, in the instance of a pandemic of bird flu or H1N1 flu in any city. Many people who may have other less serious maladies and must go to the hospital may contract the bird flu or H1N1 flu, by being in the hospital waiting room for 4 or more hours. Thus the hospital waiting room will become the instrument of intensification and avail spreading of the pandemic.

With the current legacy system people come into the hospital waiting hall as early as they can. Some would be driving around trying to find an available parking space. Also going out to pay for extension of parking. The current existing queue system requires the patient to be physically in front of a ticket dispenser to take a number and enter queue. So patient must take leave from work or school all day to go to the hospital and take the queue number from the queue machine in the waiting hall. This activity results in energy wasted and productivity wasted and danger to staff and patients from contagion. Productivity will be increased by this invention. And energy consumption/pollution will also be reduced. To quantify the potential (man hours of work lost) and savings one might simply multiply the average number of hours searching for parking, time spent in a waiting room and compare to the time saved by using Queue Management System with advance appointment timing. For example 1 hour searching for parking plus 6 hours in a waiting room. This is opposed to using Queue Management and receiving a queue line number and approximate appointment time (½ hour waiting with someone dropping patient off and picking up.) A potential of 6.5 hours of productivity gain.

Another advantage of the invented Queue management system is that a patient can be screened by questionnaire and be immediately assigned to appropriate specialty doctors and examining rooms. Thus further streamlining the process and increasing efficiency. Another benefit would be that a patient may be so afraid of contacting an infectious disease or fear of missing work that he or she might decide not to go see a doctor when they need to. And that might lead to serious complications and an infirmity not being detected and reported to authorities or contained. This scenario may result in a pandemic disease spreading out even faster into communities, cities and states. The Queue Management system will thus encourage the individual to go to the health care facility and seek help because of the convenience and simplicity of remotely obtaining a queue number and saving time and money. This system will then ultimately serve to prevent or limit severity of a pandemic disease. The invented device or system may also function as stand-alone, allowing the request by SMS the text to obtain queue number and also allowing the request by pressing button at the waiting hall to take a number and wait to be called for service. Or as recommended as a combination of available components for a complete solution thus giving entity maximum efficiency in personnel, asset control and performance.

The same benefits would apply to attendance at many government offices and facilities. or people waiting in long lines for customer services. Such as the Department of Motors Vehicle (DMV), the department of state taxation, the Internal Revenue Service office, the social security administration, college registration/admission offices etc. The benefits of productivity gain and energy savings along with increased revenue collection would apply as well to these agencies as in a health care environment.

Also in the present legacy queue management system, which consists of merely taking a number and waiting, there is NOT enough statistical analysis data and real-time datum. This would include average patient wait time, time with each individual doctor and other variables. This system is flexible and scalable with numerous user options and configurations. It is able to easily be adjusted and fine tuned once parameters, variables and statistics for each individual entity are detected for ultimate efficiency. It will then be able to inform the patient and staff more accurately as to how long the estimated waiting time would be as well as personnel and asset usage. As one can see the benefits of scheduling efficiency and ease of use resulting in disease prevention and/or containment along with resource savings makes the Queue Management system a valuable asset to modern government or business.

### BRIEF DESCRIPTION OF THE FIGURES

Embodiments of the invention are illustrated in the Figures of the accompanying drawings in which:

FIG. 1 depicts an example of the new queue management device. It allows remote requests by Short Message Service (SMS) text sent by patients in order to get a reply by Short Message Service (SMS) text for tickets indicating queue number and approximate waiting time and what number is currently being served. The queue management device firmware/software will send a Short Message Service (SMS) text to the requester patient once it has identified the caller ID telephone number and it then generates the queue number. The requester patient, will receive back by text message the queue number assigned to them, with current queue number that is being served, along with the approximate wait time, thus indicating a future time to arrive. It also allows a patient to be physically present in front of kiosk device, and be able to press the distribution button on the touch screen and to get the printed queue numbered ticket from the device. This will interface with the complete database. The queue management device firmware/software also communicates with the LED or LCD display so that the display would show the current queue number currently being served at the waiting hall.

FIG. 2 depicts an example of the new queue management device as in FIG. 1 but has more additional features, being connected to the network via Ethernet wired or wireless devices. It would have the capability to access the database on the file server and allow more adjustment control by hospital staff operators.

FIG. 3 depicts an example of the new queue management system device which allows patient or customer to request and obtain a number via Internet web page. The patients or customers can use Personal Data Assistants (PDA), Smart Cellular telephone and computer notebooks or desktops to access the website and receive and print a ticket (queue number) or down load the ticket image that can be scanned at the hospital from display on communication device screen.

FIG. 4 depicts an example of the new queue management system device as in FIGS. 1, 2, 3, with additional features allowing the request for queue number or status by the patient 115 in the block B3 via voice commands during a telephone call. The queue management device 101 will reply utilizing telephony voice processor 120. This would enable the patient who does not have cellular telephone or has no SMS feature on his/her telephone to use this system.

FIG. 5 depicts an example of the new queue management device or system as in FIGS. 1,2,3,4. With additional security dongle 517, the wide area network (WAN) 524 which allows multiple cities to connect and share the same data. The queue management device or systems also has additional server 514 connected via Ethernet wired network 523, 525, and or wireless network 523.

FIG. 6 depicts an example of the new queue management device or systems, each device cabinet 602 will be connected together by Ethernet local area network (LAN) 616. This network also may be connected with wireless access point 634 and server 606. It also may be connected to the other group of queue device network 600. The Wide Area Network (WAN) 612 also has its own group of queue management device system features. Patient 620 may still remotely request a queue number. The work group also may be connect with workstation 605, router 609, and GSM/GPRS cellular modem 608. It can also be connected to a communication network 614. The benefit of this architecture is that it can be used city wide, province/state wide, or nation wide. The data can be shared among many sites and or all sites.

FIG. 7 depicts an example of the new Queue Management device or system's typical cabinet or kiosk or queue ticket dispenser. This is one of many possible form factors. Also this invented new method allows the existing products to be upgraded to utilize a new method, if chosen by simply add-on hardware and firmware.

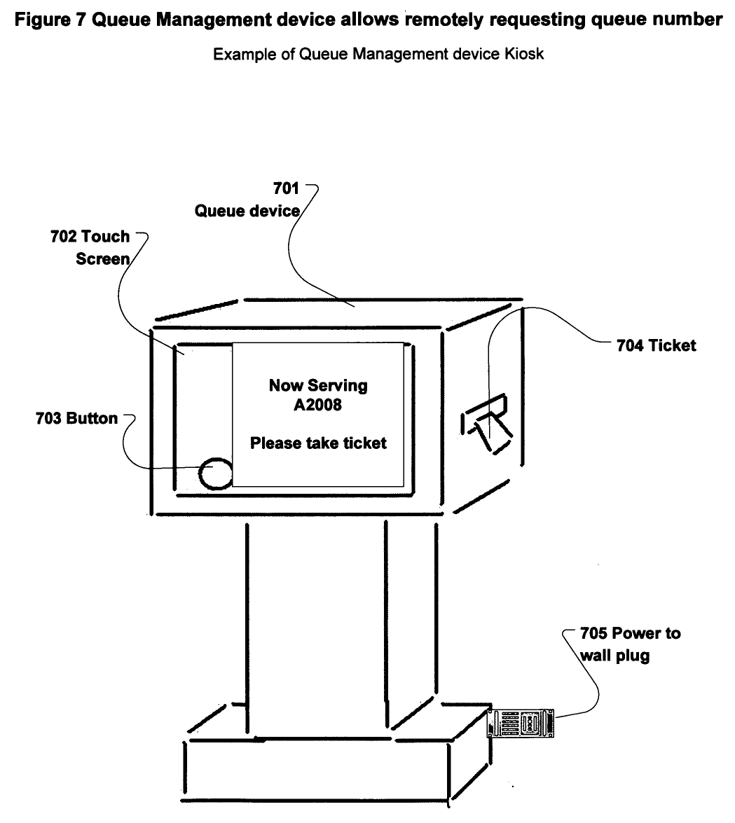

### DESCRIPTION OF THE EMBODIMENTS

This description of the embodiments is divided into five sections. The first section provides an introduction to the embodiments of the invention, while the second section describes examples of Queue management device architecture. The third section describes examples of operations performed by some embodiments and the fourth section describes examples of the Queue management device in more detail. The fifth section presents some general comments.

### First Section

Before people enter into the hospital waiting hall, they normally must first go to the hospital as early as they can so as to make sure they receive treatment or not to wait too long. Some would be driving around trying to find an available parking space when they could be dropped off or take public transportation. These actions cause needless energy and productivity waste.

The current existing queue (take a number) machine requires the patient to be physically in front of it to take a number to enter the queue. So patient must take leave from work or school and spend all day to go to the hospital and take the queue number from the queue machine in the waiting hall not knowing when he will be attended to. With the Queue Management system even this person can see the queue progression displayed as well as check in remotely to see the queue progression. Also if using the Queue Management System a patient with a particularly infectious disease, upon screening with questions, may be immediately assigned special doctors and examining room to go to because of program query. So patient does not have to wait in the waiting hall and spread the contagion as easily. Some other potential patients may be so afraid of contacting a disease or infection, they may decide not to go to see a doctor or the hospital altogether. This action could be most dangerous because this patent may be infected, contagious and untreated. Thus, this infection is not detected and reported to authorities so to be treated and/or quarantined. This situation may result in a pandemic accelerating. The Queue Management System will encourage citizens to go to the hospital and receive help because of the convenience and ease of remotely obtaining the queue number and time of treatment. This system can help prevent an undetected pandemic disease by helping contain it. This new invention will help encourage sick people to go see a doctor and reduce mixing with and infecting the healthy or becoming infected by the sick in waiting room by virtue of lack of exposure time.

The same reasoning would apply to many crowded government offices. Many people are waiting so long in line for customer services, when conducting business with many government offices due to lack of resources. With the urban population rise overcrowding is inevitable. These offices would include; the Department of Motors Vehicle (DMV), the department of state taxation, the Internal Revenue Service office, the social security administration, the college registration/admission offices), This situation will result in productivity loss as well as government losing accurate records and revenues. Many taxation offices may lose revenue that would have been collected in timely manner for government's budget schedule. Once again, think of the Queue management system as a time management system, and resource multiplier. With an advanced appointment system like this the resources of personnel and building space are increased by a sizable factor. Thus this system is in effect a huge revenue generator.

Realizing that productivity and resources could be lost when people go to a hospital or business and wait all day for appointment was the impetus for the creation of this system. We wished to develop a new modernized method to allow people to remotely request and reserve a queue number without having to be present in person. Thus preserving these aforementioned resources as well as helping limit disease contagion. We also observed the efficiency and popularity of SMS text messaging and incorporated this in the system as well as other means of modern remote communication.

The firmware in the queue management device, and the program will receive the SMS text request for queue number from the patient. The device will generate the queue number and manage all other queue numbers and will estimate waiting time based on statistics of past activities and program adjustments. This new queue management device will also allow the patient in the building to touch the screen button and receive the printed queue number ticket. Program will also interact with remote requests from other means of communication to create a cohesive unit. So a patient can use his or her mobile telephone, hand set, computer or land line to request a queue number and/or status as well as receive a number and check status in the building.

Example of the SMS text requesting would be: “#1123456789012345678901234,#2123,#3107” This example is one of many configurable requirement sets. The “#1” followed by 24 number would represent the national ID card. The #2 followed by 123 would indicate doctor number. The #3 followed by 107 would be department number. The queue number will be assigned to him/her by the firmware/software. The queue management device will send the SMS text containing an assigned queue number with approximate service time to the requester. The queue management firmware knows where to send the SMS by identifying the caller ID telephone number. The example of the reply SMS text message would be: #4A2172,3:20,A2084. The #4 would indicate the queue number would be A2172. The 3:20 would be the waiting time of about 3 hours and 20 minutes. The A2084 is shown to be the currently serviced number of A2084. So, a patient can plan when to drive his or her car, be dropped off, or take a bus or a taxi, to the hospital. If he or she is working daily, there is no need to take a prolonged absence from work for a whole day when program gives accurate schedule information. He or she would only leave office or factory to arrive at approximate, appointed time. So he or she would only spend a short time in process, and return back to work much quicker than by using present queue systems deployed throughout the world. The Queue Management device and system can also be configurable to set the SMS request format and reply format.

For example, the format given above may be changed to: The request format example: “#A123456789012345678901234,#B123,#C107”, which #A is represented nation ID, #B represents department, and #C is represents desired doctor. The reply would be as in the example: #QA2172,3:20,A2084. The #Q would indicate the queue number would be A2172, approximate waiting time before this number will be called is about 3:20 hours from now, and currently the queue number A2084 is being called and served.

Here is another feature and example of the flexibility of this system. It can be used to further simplify queue process as well as guiding the patient to the correct department. The Firmware/software will employ an algorithm to allow a patient/customer to obtain an appointment or queue number by simply texting a keyword to Queue Management System. All information cited previously could be configured differently by hospital/user or patient/client. An example would be using keywords such as #2 (which is the department) and/or symptom such as eyes or #2 fever or #2 dentistry; or “#2 fever”. All is user configurable. On the other hands, some may not require anything but “#” as a requesting sentence. The queue firmware/software will accept this information and send back to patient information for correct routing for specific department such as dentist or optometrist or for specific symptom such as fever or influenza.

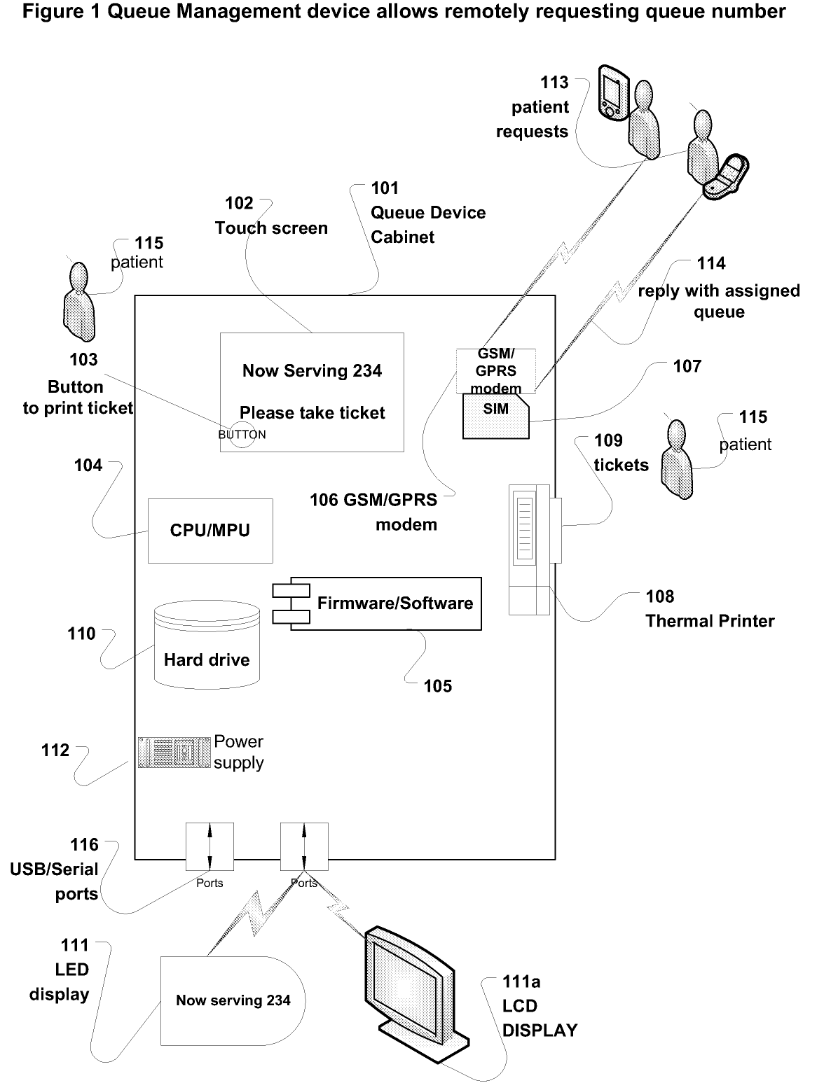

FIG. 1 depicts an example of new queue Management machine which would allow the patient 115 to press button 103 on the touch screen and take a printed and assigned queue number 109 from the ticket dispenser within the machine. That is if the patient or customer is at the waiting hall and chooses to physically access the queue management device. In theory this would be the same process as the existing queue management machine such as Q-MATIC. Nevertheless the invented Queue Management machine has a vastly improved design with many more features. The new system and method allows patients or customers to remotely request the queue ticket number in real-time or almost real-time without having to be in the physically present. The cabinet 101 comprises a touch screen with display button 103 to be pressed by patient or customer 115 for assigning queue number and printing the ticket 109 for customer or patient 115, the hardware 104 CPU/MPU that indicates a processor and system board. The Firmware/software 105 that controls the queue management machine, not only allows patient to touch the button on the screen and get the ticket when he/she is at the location, it also would be receiving the remote requests and would be assigning queue numbers, then sending SMS text information to the requester and saving the transaction data. This firmware/software 105 is also analyzing the statistics of the ongoing activities. It also would allow user to configure the rules, settings, text message phases, etc. The GPRS/GSM modem 106 with SIM card 107 shall handle the receiving and transmitting of SMS text message via cellular phone service on GSM or GPRS cellular telephone network. The thermal printer 108 would print queue number ticket 109 and dispense it out for the patient/customers 115 who pressed the button 103. The power supply 112 plugs into the electrical outlet for power. The hard drive 110 is for storing transaction data of all queue requests and history as well as issuing new responses and displaying what number is currently being served. The LED display unit 111 will display the current number that is being called. The LCD or plasma screen 111a also could be used to display now serving number. The USB/Serial port 116 is for connecting cable between the queue management machine and the LED display unit. The patient/customer 113 shall use his/her cellular device, send the SMS requesting the queue number. Or other mentioned communication device. The queue management machine will then issue the queue number and send to the requester 114.

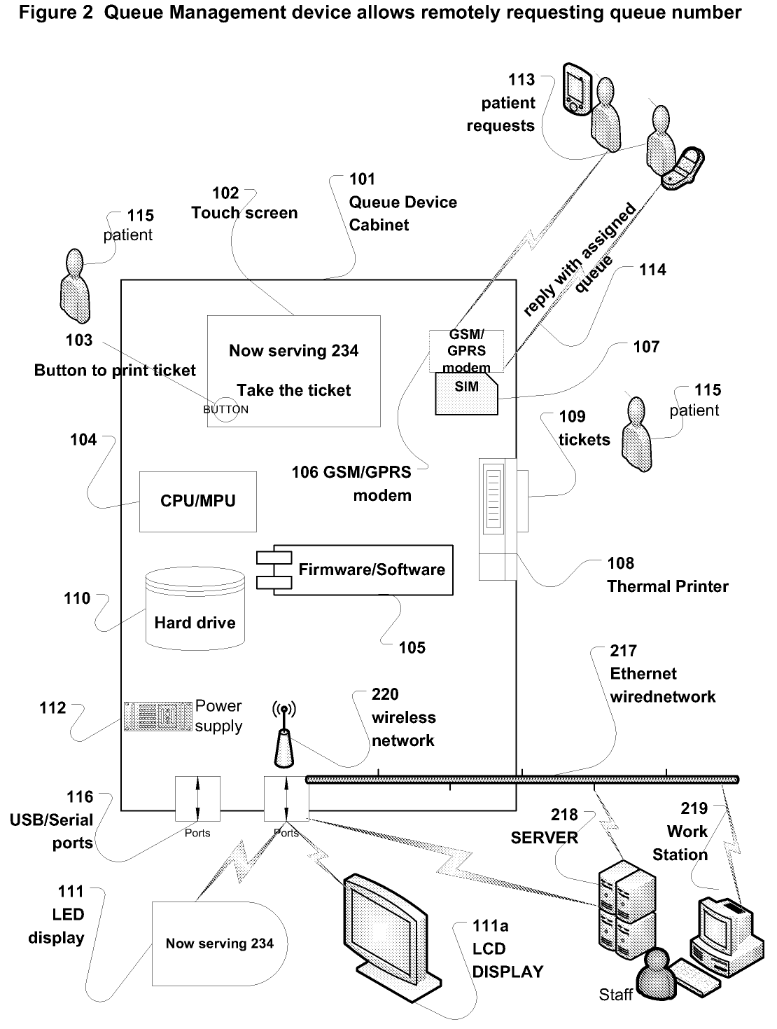

The example depicted in FIG. 1 and FIG. 2 (and subsequent Figures) does not depict every possible embodiment. Embodiments can implement various aspects differently. For instance, additional voice commands feature could be further implemented. So the patients or customers would call and chose key press and voice commands. This would be implemented with both hardware and software, etc. Further, the stages are intended to aid in understanding the embodiments, and should not be used to limit the scope of the claims. Despite the presumed order illustrated in FIG. 1, embodiments can perform the operations of stages B1 which patient must be at the machine to obtain the queue number ticket. And the stage B2 allows remote requesting by patient via Short Message Service (SMS) text in different order, in parallel, etc. Likewise, the operations depicted in the stages of FIG. 2 can be performed in any order, in parallel, etc.

Although FIG. 2 depicts other connectivity with server and workstations via Ethernet 117 or wireless Ethernet 120. It does not necessarily require it in the operation. It is rather an option.

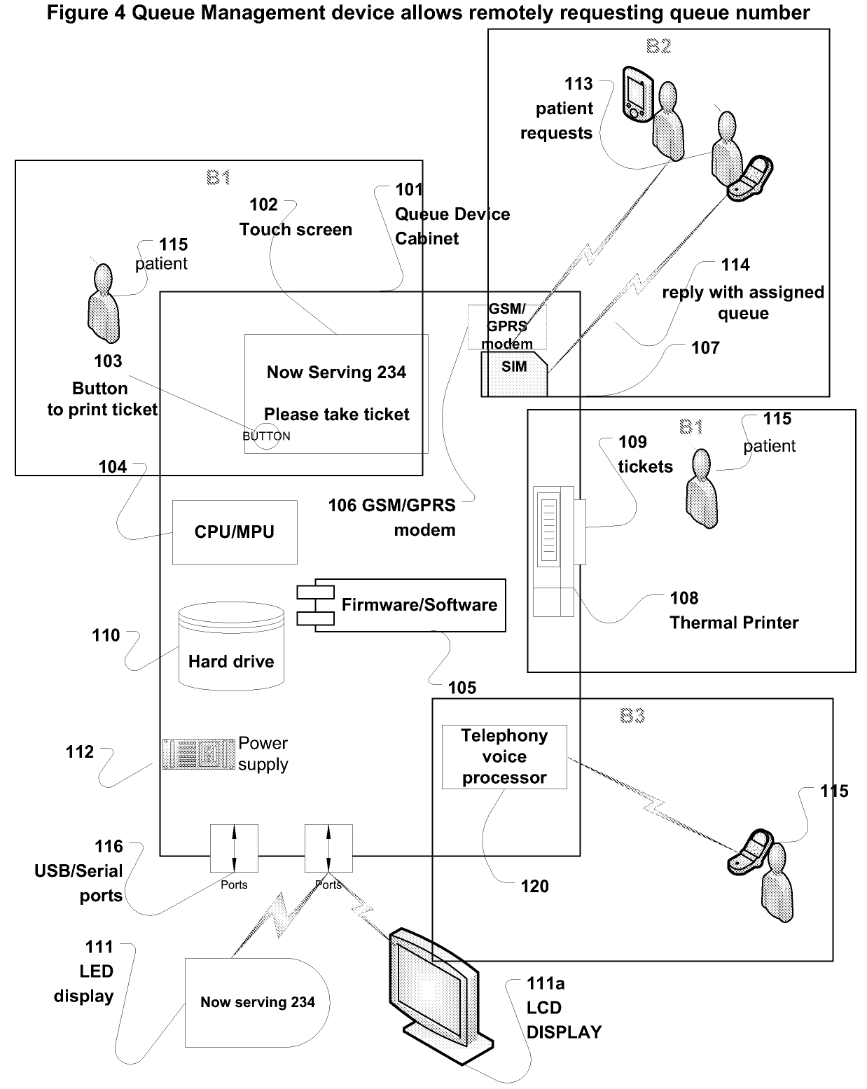

Again, it should be understood that FIGS. 1-4 depict examples intended to aid in understanding embodiments, and should not be used to limit embodiments. For instance, FIGS. 1 and 2 refer to a queue management device. Embodiments can use the compounding for one or more of a queue management device, a computer server and client computer systems with an operating system, firmware and software, add-on, software patch, upgrade, attached electronics device making the system able to function as the invention is followed, etc.

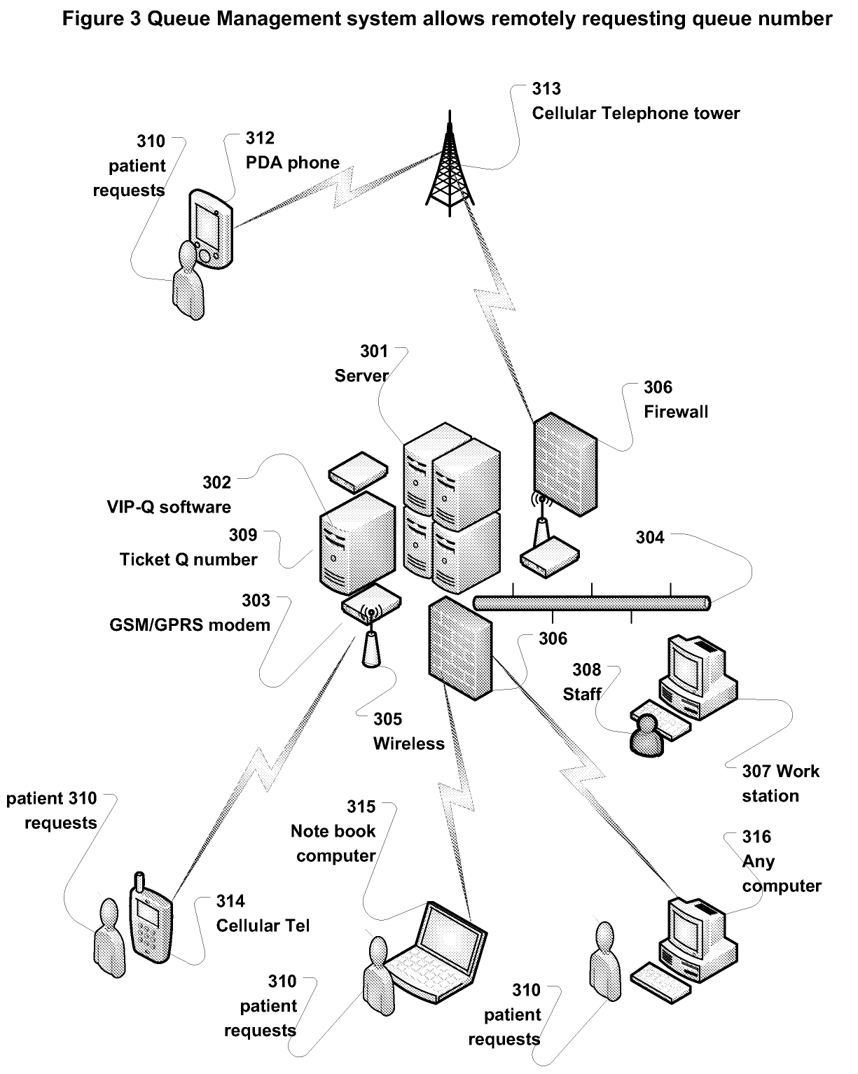

Variations in embodiments are not limited to different operations. The order of operations depicted in FIGS. 1-4 can vary among embodiments. For instance, embodiments can perform the operations depicted at 301 and 316 of FIG. 3 in any order, in parallel, etc. In certain embodiments, the operations can be performed by executing instructions residing on machine-readable media (eg., software), while in other embodiments, the operations can be performed by hardware and/or other logic (e.g., firmware).

### Queue Management Machine Architecture

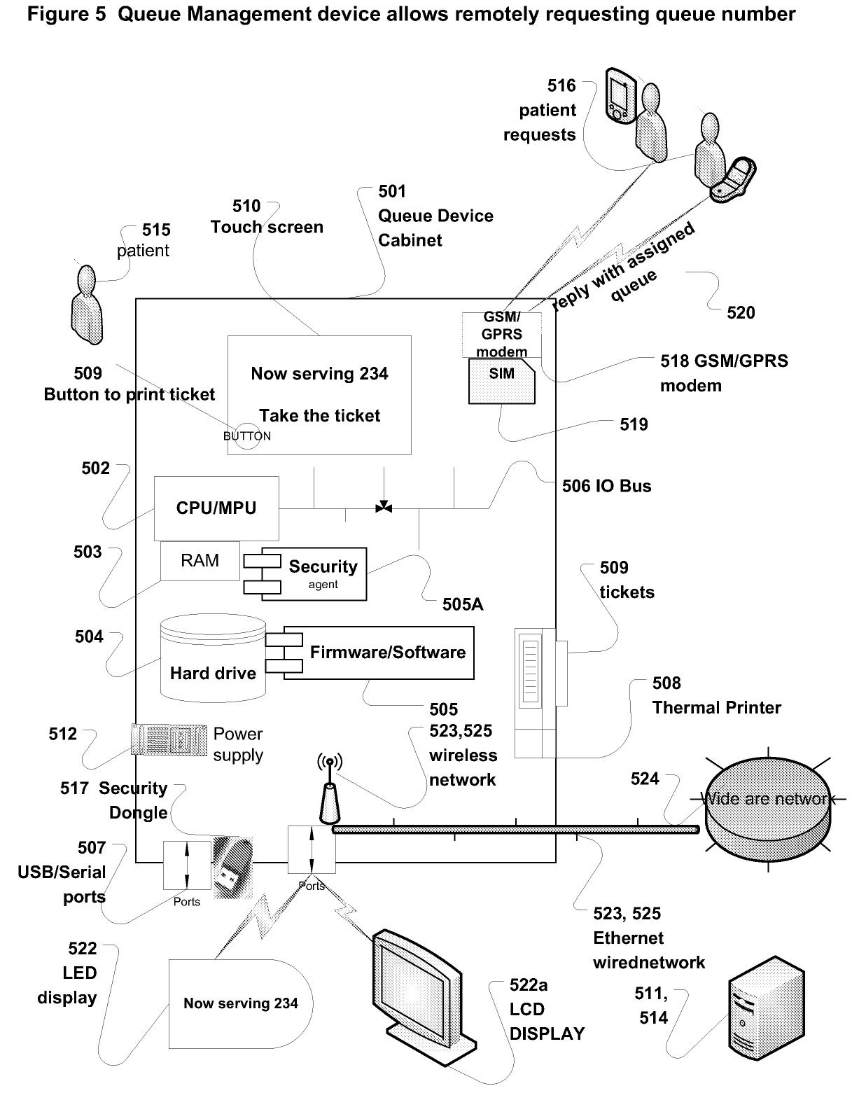

FIG. 5 is a block diagram illustrating the queue management machine architecture, according to example embodiments of the invention. As shown in FIG. 5, the queue management machine architecture 500 includes a queue management machine 501, which includes a central processing unit (CPU) 502 connected to main memory 503. The CPU 502 can include any suitable processor, such as an Intel® Pentium processor, Intel® Core 2 Duo processor, AMD Opteron™ processor, or UltraSPARC processor. The queue management machine 501 includes a hard drive 504 which contains the queue management firmware/software unit 505. In one embodiment, the queue management device unit 501 can present queue management devices, etc., in whole or part. The main memory 503 also comprises a security agent 505. The security agent 505 detects use of a security dongle (e.g., communications through a wireless port, physical connectivity via an electrical port, etc.) with the queue management machine 501 to enable software and/or hardware. The security agent 505 performs operations to obtain data from the security dongle for compounded security (e.g., authentication of data in a secure or non-secure area of the security dongle). The security agent 505 can perform any of the operations described previously.

The CPU 502 is also connected to an input/output (I/O) bus 506, which can include any suitable bus technologies, such as an AGTL+ front side bus and a PCI back side bus. The I/O bus 506 is connected to a thermal printer mechanism 508, primary display 510, secondary display 522, button input device 509, and storage unit 511. The I/O bus 506 is also connected to an external system interface 523, which is connected to external systems 514 (e.g., queue management device networks).

In one embodiment, the queue management machine 501 can include additional peripheral devices and/or more than one of each component shown in FIG. 5. For example, in one embodiment, the queue management machine 501 can include multiple external system interfaces 525 and/or multiple CPU's 502. In one embodiment, any of the components can be integrated or subdivided.

Any component of the architecture 500 can include hardware, firmware, and/or machine-readable media including instructions for performing the operations described herein. Machine-readable media includes any mechanism that provides (i.e., stores and/or transmits) information in a form readable by a machine (e.g., a queue management machine, computer, etc.). For example, tangible machine-readable media includes read only memory (ROM), random access memory (RAM), magnetic disk storage media, optical storage media, flash memory machines, etc. Machine-readable media also includes any media suitable for transmitting software over a network.

While FIG. 5 describes an example queue management machine architecture, this section continues with a discussion of queue management device networks.

### Queue Management Device Networks

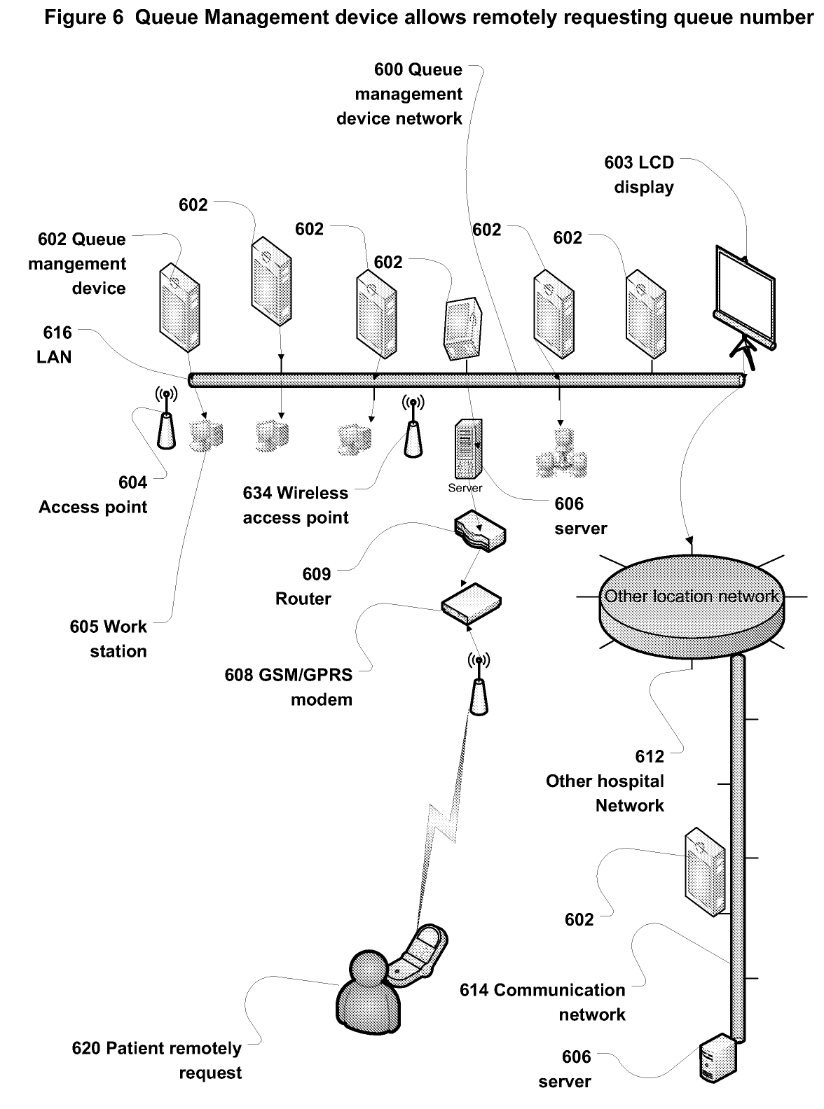

FIG. 6 is a block diagram illustrating a queue management device network 600, according to example embodiments of the invention. As shown in FIG. 6, the queue management device network 600 includes a plurality of the queue management device 602 connected to a communications network 614.

Each queue management machine/device 602 includes a local area network 616, which includes an access point 604, a queue management device server 606, and queue management machines 602. The access point 634 provides wireless communication links 610 and wired communication links 608. The wired and wireless communication links can employ any suitable connection technology, such as Bluetooth, 802.11, Ethernet, public switched telephone networks, SONET, etc. In some embodiments, the queue management device server 606 can serve queue management devices and distribute content to devices located in other hospitals 612 or at other locations on the communications network 614. The queue management device server 606 can also operate as a license server. Embodiments can also implement the queue management device server 606 to perform operations for enhancing security with a security dongle for software/hardware facilitation. (e.g., providing public keys).

The queue management machines 602 described herein can take any suitable form, such as floor standing models, hand held mobile units, counter top models, workstation-type console models, etc. Further, the queue management machines 602 can be primarily dedicated for use in conducting queue management devices, or can include non-dedicated devices, such as mobile phones, personal digital assistants, personal computers, etc. In one embodiment, the queue management device network 600 can include other network devices, such as accounting servers, wide area hospital database servers, patient tracking servers, and/or other devices suitable for use in connection with embodiments of the invention.

In some embodiments, queue management machines 602 and queue management device servers 606 work together such that a queue management machine 602 can be operated as a thin, thick, or intermediate client. For example, one or more elements of queue request, queue assignment, queue management may be controlled by the queue management machine 602 (client) or the queue management device server 606 (server). Queue management elements can include executable queue management code, look up tables, configuration files, queue assignment outcome, audio or visual representations of the queue management function assets or the like. In a thin-client example, the queue management device server 606 can perform functions such as determining game outcome or managing assets, while the queue management machine 602 can present a graphical representation of such outcome or asset modification to the user (e.g., patients, hospital staff). In a thick-client example, the queue management machines 602 can determine queue number assignment, queue management, reports, statistical analysis and communicate the operations to the queue management device server 606 for recording or managing a patient account.

In some embodiments, either the queue management machines 602 (client) or the queue management device server 606 can provide functionality that is not directly related to queue management. For example, account transactions and account rules may be managed centrally (e.g., by the queue management device server 606) or locally (e.g., by the queue management machine 602). Other functionality not directly related to queue management may include power management, presentation of advertising, software or firmware updates, system quality or security checks, image delivery etc.

Any of the queue management device network components (e.g., the queue management machines 602) can include hardware and machine-readable media including instructions for performing the operations described herein.

### General

This detailed description refers to specific examples in the drawings and illustrations. These examples are described in sufficient detail to enable those skilled in the art to practice the inventive subject matter. These examples also serve to illustrate how the inventive subject matter can be applied to various purposes or embodiments. Other embodiments are included within the inventive subject matter, as logical, mechanical, electrical, and other changes can be made to the example embodiments described herein. Features of various embodiments described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments of the invention, which are defined only by the appended claims. Each of the embodiments described herein are contemplated as falling within the inventive subject matter, which is set forth in the following claims.

1. A method comprising:
performing a queue management functionality; for enabling patient or customer to remotely send the request for Short Message Service text message and receive back the assigned queue number, the estimated waiting time, the currently being served number, and numerous other configured functions deemed necessary by the hospital administrator. Ability to receive all remote requests of the queue number by Short Message Service (SMS) from any patient's or customer's cellular Telephone device. Also checking for duplicated requesting, and or generating a new queue number and or sending the assigned number via the Short Message Service back to the sender/requester identified from the caller ID telephone number. The sending SMS may include a currently being served number and an approximate time the requester is recommended to be present in the waiting hall to be called to receive health care service or customer service.
What happens if client misses time of appointment? Back of line issue new #? This could be easily handled by user's configurable in the firmware/software. The invented queue management device will handle it accordingly. In other word, that particular queue number could be allowed to be the next in line to be served. If the hospital administration sets the rule that way. Or it could be altogether canceled and patient or customer must request the new queue number over again.
It may obtain or generate and issue a queue number from the central control subroutine in the software, or from the server software wherein the queue number will be sent to the requester with or without estimated waiting time and with or without current serving queue number.
It may require that the patient or requester supply the national identification number, driver license number, patient number, or an acceptable identification source from the remote patient or requester.
It may set forth rules of format of the Short Message Service text sentence format of the sentence that user or patients must follow to successfully obtain the queue number and necessary information related to the queue management

2. The method of claim 1, wherein the piece of software comprises at least one of a queue management device, a queue management device software or firmware, an operating system, an add-on, an upgrade, and a component of an operating system.

3. The method of claim 1, wherein said performing the first receipt of SMS comprises one of determining that a SMS message is received to request the queue number by a non duplicated requester and then issues the queue number obtained from the central memory or local database or central database and or local subroutine queue number generator. The piece of software or firmware on the queue management machine, also keeps track of all received and all sent SMS messages, and determines that no duplicated number is given throughout the systems within the network.
All SMS messaging requesting formats and reply formats can be user configurable. Messaging can also include querying for more efficient directing of service such as department or symptom.

4. The method of claim 1, wherein said performing the secondary function measure keeping track of currently called or served number.

5. The method of claim 4, wherein said keeping track of the queue number currently serving and keeping track of each number serving time and calculate the elapsed time between one queue number to the next.

6. The method of claim 4 and claim 5, can be combined and then take the elapsed time result and inform patients or customers of the approximate waiting time. The requester or patient or customer can use the information and make adjustment to apportion their time schedule to do other things without having to waste time, go in and wait in the waiting hall.

7. The method of claim 6, wherein the estimated wait time and current number being served are provided to the requester or patient would be beneficial as to the following:
a)Time that could have been efficiently used to do other things is not wasted
b) No gasoline is wasted, if one must drive around to find a parking space.
c) No overtime parking meter cost or more parking cost to patient. Could be dropped off or take public transportation if approximate times were known.
d) No patient would be unnecessarily waiting in the waiting room full sick people. It would reduce chances of having a pandemic disease spread quicker throughout the community.

8. A method comprising:
An embedded device or computer systems consisting of a thermal printer, printable paper, power supply, touch screen, USB/serial ports, CPU and system board, the GSM/GPRS modem, SIM card from Cellular telephone company, hard drive, operating system, firmware/software to control and provide all functionality from all claims here in.

9. The method of claim 8, wherein the first piece of software comprises at least one of an executable queue management device and an operating system.

10. The method of claim 9, wherein the second piece of software comprises at least one of an upgrade, an additional queue management device feature, and an operating system component.

11. A method comprising: The telephony software/firmware is implemented to handle the voice commands. In other words, the invented queue management device will be receiving a voice call, which allows patient who is the caller to press the key for options or speak out the commanding words. This method would help people who cannot read or write, or for the regular telephone that has no ability to compose the text nor send it via Short Message Service. i.e. land line, public telephone, etc.

12. The method of claim 11 further comprising successfully performs the reply function providing the queue number. The patient must keep referenced number and inform the hospital staff who will look up in the system and verify data.

13. The method of claim 11, wherein the system may allow the patients to call in day or days in advance. Thus, this would be come an appointment system as well.

14. The method of claim 13, wherein the code comprises at least one of a queue management, an operating system upgrade, an operating system patch, and a feature list.

15. One or more machine-readable media having stored therein instructions executable by a processor, wherein executing the instructions causes the processor to perform operations that comprise:
performing a first security measure with a security dongle for enabling a piece of software on a queue management machine;

16. The machine-readable media of claim 15, wherein the piece of software comprises at least one of a queue management device, a queue management device theme, an operating system, an add-on, an upgrade, and a component of an operating system

17. The machine-readable media of claim 15, wherein said operation of performing the first security measure with the security module.

18. The apparatus of claims 1 to 17, wherein the queue service provider routine is further applicable to: Other government business offices and/or any other industry that requires queue management or may find this system beneficial.

19. In addition to the method in claim #8, the queue machine may also employ an additional electronic sensor to allow a “non tactile” option to sense object, finger or hand from the patient or patron without actually touching a surface. Electronic sensor would trigger the printing and dispensing of a physical queue ticket from queue machine. This would function the same as sequence being triggered by activation of a physical button, or touch screen. In other words, the newly invented Queue machine may also deploy an electronic sensor. The patient or patron would simply place his finger, his object, or hand close to the sensor, the sensor will trigger the dispensing of the queue ticket and number. This would be within the scope and framework of the invention in addition to the previously cited alternatives, and would not be mutually exclusive.
This invention would allow the patient or patron to avoid touching any potentially contaminated surface button or touch screen. It would help alleviate contamination from germs and virus's such as the flu or H1N1 or any pandemic disease.
The use of a “hands free” or “no touch” option to dispense a ticket number would be especially advantageous in a hospital or clinic environment. Or in any venue where germ or disease contagion is possible, which is anywhere that people congregate in proximity.

20. In addition to the previously cited means/method in claim #1 of transmitting pertinent data to clients via the Queue Management System could be the use of MMS, or multimedia messaging system. This is the standard for sending multimedia objects (images and text.) This could be sent to cell phone, PDA/smart phone, email or any other communications device.
Within the scope of this invention this could take the form of a picture, bar code, coupon, prescription, demonstration, instructions, or ticket.
